(19) United States
(12) Patent Application Publication
(10) Pub. No.: US 2009/0038930 A1
(43) Pub. Date: Feb. 12, 2009

(54) FOIL-TYPE SWITCHING ELEMENT WITH ENHANCED CARRIER FOIL

(75) Inventor: Driss Chabach, Noertrange (LU)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., Echternach (LL)

(21) Appl. No.: 11/720,468

(22) PCT Filed: Nov. 29, 2005
(86) PCT No.: PCT/EP05/56305

§ 371 Date: May 30, 2007

(30) Foreign Application Priority Data
Dec. 1, 2004 (EP) 04106229.0

(51) Int. Cl. H01H 35/34

(52) U.S. Cl. 200/83 B

(57) ABSTRACT

A pressure sensor comprises at least one first carrier foil, which is mounted on a supporting element so as to span an active area of said pressure sensor. According to the invention said first carrier foil comprises a material chosen from the group consisting of polyetheretherketone, polyethersulfone, polyphenylsulfone, polysulfone, polycarbonate, copolycarbonate, polyphenylene ether, cyclo-olefin-polymer, polycarbonate/acrylonitrile butadiene styrene, polycarbonate/polybutylene terephthalate, polycarbonate/polyethylene terephthalate, polyphenylene ether/polyamide, or mixtures thereof.

The present invention generally relates to a foil-type pressure sensor comprising at least one carrier foil, which is mounted on a supporting element arranged at a periphery of an active area so as to span said active area, and means for determining a pressure-induced deformation of said at least one carrier foil.

One group of this kind of pressure sensors comprises single membrane sensors, in which the deformation of a single carrier foil is directly determined e.g. by optical means or by strain gauges. The response of these pressure sensors is directly determined by the mechanical response of the carrier foil in case of a force acting on the active area. This mechanical response depends on the elastic properties of the carrier foil, usually a PET foil and the lateral dimension of the active area.

A different group of pressure sensors comprise double membrane sensors, in which a first and a second carrier foil are arranged at a certain distance from each other by means of a spacer. The spacer comprises at least one recess, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure transducers having an electrical resistance, which varies with the amount of pressure applied. In a first embodiment of such pressure transducers, a first electrode is arranged on the first carrier foil and a second electrode is arranged on the second carrier foil in facing relationship with the first electrode. At least one of the electrodes is covered by a layer of pressure sensitive material, e.g. a semi-conducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of the pressure transducers, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice.

The electrical response of such a pressure sensors depends on the type of the electrodes, the presence of a possible layer of pressure sensitive material, the design of the electrodes and their arrangement within the active area of the switching element and finally on the physical contact, which is established between the electrodes in response to a force acting on the active area. The physical contact between the electrodes is determined by the mechanical response of the switching element in case of a force acting on the active area. This mechanical response depends on the elastic properties of the carrier foils, the lateral dimension of the active area and the distance between the two opposed carrier foils.

For a given size and configuration of the switching element, the mechanical response of both types of pressure sensors can be adapted by adjusting the mechanical properties of the carrier foils. The carrier foil of known foil-type switching elements consists usually of a plastic sheet material such as PET or PEN, which if necessary has undergone a surface treatment in order to enhance the adhesion on the printed electrodes. However the elastic properties of these materials do not always correspond to the requirements with respect to the mechanical response of the switching element. For instance, the graph of the modulus of elasticity versus temperature of PET or PEN shows a significant step at respective threshold temperatures, which confers a non-optimum behaviour to the switching element.

Another material, which is used for the carrier foils, is polyimide PI. The modulus of elasticity of PI shows only little variations over a wide temperature range e.g. from −50° C. to +200° C. This mechanical property of PI is well suited for the pressure sensor applications, however PI is very expensive compared to PET of PEN.

Thus there is a need for pressure sensors with enhanced carrier foils. In order to provide a solution to this problem, document WO-A-2004/053908 discloses a foil-type switching element wherein at least one carrier foil comprises a multi-layered configuration with at least two layers of different materials. By the use of appropriate materials and by suitably dimensioning the thickness of the different layers, the mechanical properties of these multi-layered carrier foils may be precisely tuned to the specific requirements of a wide range of applications. However, due to severe production tolerances, these multi-layered carrier foils are difficult to produce and accordingly rather high cost.

### OBJECT OF THE INVENTION

The object of the present invention is to provide a pressure sensor with enhanced carrier foil.

### GENERAL DESCRIPTION OF THE INVENTION

This object is achieved by a foil-type pressure sensor according to claim 1. This pressure sensor comprising at least one first carrier foil, said first carrier foil being mounted on a supporting element so as to span an active area of said pressure sensor. According to the invention said first carrier foil comprises a material chosen from the group consisting of polyetheretherketone, polyethersulfone, polyphenylsulfone, polysulfone, polycarbonate, copolycarbonate, polyphenylene ether, cyclo-olefin-polymer, polycarbonate/acrylonitrile butadiene styrene, polycarbonate/polybutylene terephthalate, polycarbonate/polyethylene terephthalate, polyphenylene ether/polyamide, or mixtures thereof.

The function and performance of the pressure sensitive switching elements e.g. for passenger detection and classification depend strongly on the membrane performance, i.e. on the mechanical properties of the carrier foil. To keep a stable and constant sensor function the carrier foil should show e.g. a very low elasticity modulus variation in the temperature range between −40° C. and +105° C. and should be resistant to high corrosive and humidity conditions under mechanical stress. Furthermore a high resistance against humidity is preferable. The above-mentioned carrier foil materials meet these criteria and are therefore well suited for the use in pressure sensors e.g. in automotive safety applications.

In a possible embodiment of the invention, said first carrier foil comprises a polymer alloy chosen from the group consisting of polycarbonate/acrylonitrile butadiene styrene PC/ABS, polycarbonate/polybutylene terephthalate PC/PBT, polycarbonate/polyethylene terephthalate PC/PET, polyphenylene ether/polyamide PPE/PA, or mixtures thereof. An alloy or blend is a mixture of two chemically diverse polymers to form a substantially homogenous product, having enhanced properties that are a combination of the two different polymers. The use of alloy polymers as a membrane in the sensor will enable to improve the mechanical strength of the carrier foil and to improve the heat and chemical resistance of the material.

In another embodiment said first carrier foil comprises a polyetheretherketone foil. Polyetheretherketone (PEEK) is a very suitable carrier foil material due to the very low variation of its elasticity modulus over a large temperature range, very interesting price and material availability as compared e.g. to polyimide. The properties of PEEK could be summarized as: high degree of rigidity, excellent chemical resistance, abrasion and flame resistance, high temperature performance and excellent hydrolysis resistance.

In another embodiment said first carrier foil comprises a sulfonated polymer chosen from the group consisting of polyethersulfone PES, polyphenylsulfone PPSu, polysulfone PSu or mixtures thereof. Sulfonated films are very suitable carrier foil materials due to the very low variation of its elasticity modulus over a large temperature range, very interesting price and material availability compared to polyimide. Their properties may be summarized as: low creep, high strength, self-extinguishing, good hydrolytic stability, high service temperatures.

In yet another embodiment said first carrier foil comprises a polycarbonate polymer chosen from the group consisting of polycarbonate PC, copolycarbonate CoPC or mixtures thereof. Polycarbonate and copolycarbonate films are suitable carrier foil materials due to the very low variation of their elasticity modulus in the temperature range between −40° C. and +105° C., the low price and the high material availability as compared to polyimide.

In yet another embodiment said first carrier foil comprises a polyphenylene ether foil. PPE polyphenylene ether films are suitable carrier foil materials due to the very low variation of their elasticity modulus in the temperature range between −40° C. and +105° C., the low price and the high material availability as compared to polyimide.

In yet another embodiment said first carrier foil comprises a cyclo-olefin-polymer foil. Like the materials described above, COP Cyclo-olefin-Polymer films show advantageous mechanical properties and reasonable material costs.

It will be noted, that the pressure sensor of the present invention may be a single membrane sensor, in which the deformation of a single carrier foil is directly determined e.g. by optical means or by strain gauges. The response of these pressure sensors is directly determined by the mechanical response of the carrier foil in case of a force acting on the active area.

In a preferred embodiment of the invention, the pressure sensor further comprising at least one second carrier foil arranged at a certain distance from said first carrier foil by means of a spacer. The spacer comprises at least one recess defining an active area of the pressure sensor and accordingly acts as supporting element for the carrier foils. At least two electrodes are arranged in the active area of the pressure sensor between said first and second carrier foils in such a way that, in response to a pressure acting on the active area of the pressure sensor, the first and second carrier foils are pressed together against the reaction force of the elastic carrier foils and an electrical contact is established between the at least two electrodes. In this embodiment at least one of said first and second carrier foils comprises a material chosen from the group consisting of PEEK, PES, PPSu, PSu, PC, CoPC, PPE, COP, PC/ABS, PC/PBT, PC/PET, PPE/PA, or mixtures thereof.

For an application, where a switching element is mounted with its lower face on a rigid support and a force acts only on the upper face of the switching element, it may be interesting to provide only the upper one of the first and second carrier foils with a specific carrier foil material. However if the sensor or switching element is to be mounted on a soft support, the reaction of the support will contribute to the mechanical response of the sensor. It follows that in a preferred embodiment of the invention each of said first and said second carrier foils comprises specific carrier foil materials chosen from the cited group.

It will be appreciated, that depending on the application of the switching element, an asymmetric behaviour of the switching element may be desirable. In such a case, the properties of the first and second carrier foils are preferably different from one another. Such an asymmetric behaviour can e.g. be provided by a foil-type switching element wherein said first carrier foil and said second carrier foil comprise different materials. These embodiments allow for instance to provide a sensor or switching element, the upper side of which has a specific electrical property whereas the lower side of the sensor is specifically adapted in order to be mounted in a chemically aggressive environment. Depending on the application, the carrier foils may comprise materials having different mechanical properties. The two carrier foils may e.g. be produced of materials having different modulus of elasticity or materials, which have a dominant modulus of elasticity in different temperature ranges. The so formed carrier foils will then e.g. exhibit a higher modulus of elasticity or a more constant modulus over a wide temperature range. In this way, the mechanical response of the switching element over the temperature may be adjusted to the need of the sensor or switching element application.

It will be appreciated, that depending on the application of the pressure sensor, it might be desirable that said first carrier foil and/or said second carrier foil comprises a multilayered configuration with at least two layers of different materials. The different layers of the multi-layered carrier foil may comprise different polymer foils chosen e.g. from the above cited group or between other known materials. Alternatively one or more of said layers comprises a cured dielectric resin layer and/or a metal foil. The use of a metal foil as one of the layers of the carrier foil enables to shield the switching element against electromagnetic radiation in the environment of the switching element. Furthermore, the presence of a metal foil enables the switching element to be used simultaneously in a capacitive sensing system.

In an advantageous embodiment, one of said layers comprises a textile material. Such a textile layer, e.g. made of aramid, polyamide, polyester, etc., which may laminated onto a polymer layer or between two polymer layers, be may be used for enhancing mechanical properties as tensile strength or resistance to tear propagation without affecting the modulus of elasticity of the carrier foil.

The skilled person will appreciate, that the present invention is applicable to simple membrane switches as well as to pressure sensitive switches. In case of a simple membrane switch a first electrode is arranged on an inner surface of said first carrier foil and a second electrode is arranged on an inner surface of the second carrier foil in a facing relationship with said first electrode. In a variant of a simple switch, a first and a second electrode are arranged side by side on an inner surface of said first carrier foil and a shunt element is arranged on an inner surface of the second carrier foil in facing relationship with said first and second electrodes. The two electrodes may e.g. comprise a comb shaped configuration, with the teeth of the two electrodes being arranged in an interdigitating relationship. Foil-type pressure sensors are similarly configured as the above-described switches. In contrast to the switches, at least one of said first and second electrode is covered by a pressure-sensitive resistive material. In an alternative embodiment, the said shunt element comprises a resistive material. Due to the pressure-sensitive resistive or semi-conducting material, the electrical resistance between the electrodes of these pressure sensors depends on the pressure with which the two carrier foils are pressed together.

### DETAILED DESCRIPTION WITH RESPECT TO THE FIGURES

The present invention will be more apparent from the following description of several not limiting embodiments with reference to the attached drawings, wherein

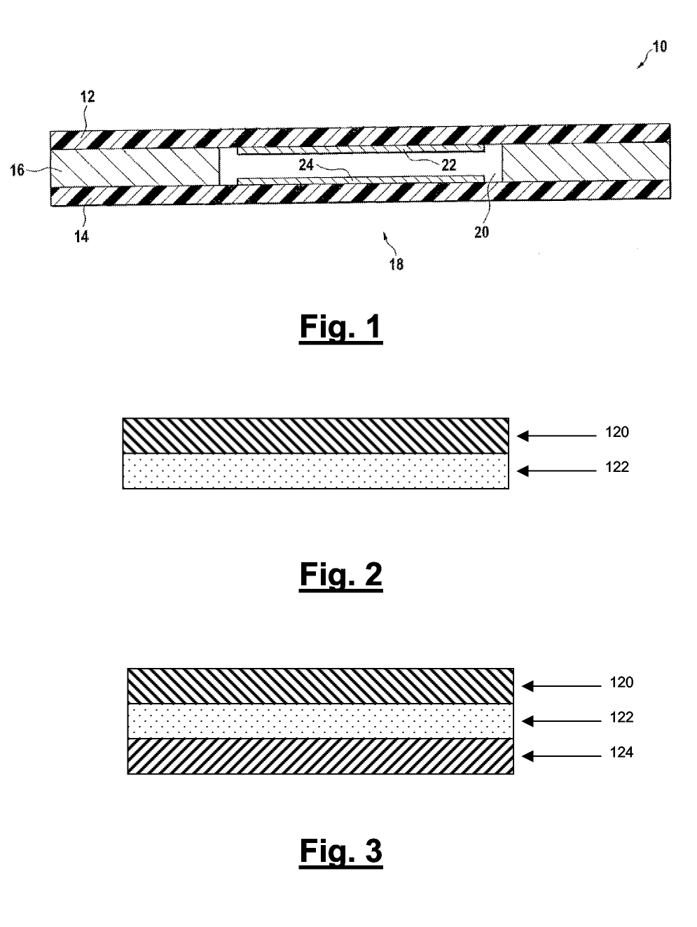

FIG. 1: generally shows a section of a foil-type pressure sensor;

FIG. 2: shows a first embodiment of a multi-layered carrier foil;

FIG. 3: shows a second embodiment of a multi-layered carrier foil.

A section of a typical foil-type pressure sensor 10 is represented in FIG. 1. The pressure sensor 10 comprises a first carrier foil 12 and a second carrier foil 14, which are arranged at a certain distance by means of a spacer 16. The spacer 16 may e.g. comprise a double-sided bonding sheet. In an active area, generally referenced as 18, of the pressure sensor 10, the spacer 16 comprises a recess or cut-out 20 such that, in the active area 18, the two carrier foils 12 and 14 face each other at a certain distance.

Contact arrangements 22 and 24 are arranged in the active area 18 on the inner surfaces of the carrier foils 12 and 14 in such a way that an electrical contact is established between the contact arrangements 22 and 24 if said carrier foils are pressed together. In the shown embodiment, one contact arrangement 22 or 24 is arranged on each of said carrier foils 12 and 14 in a facing relationship. It should however be noted that other layouts, e.g. with two spaced contact arrangements 22 and 24 arranged on one of the carrier foils and a shunt element arranged on the second carrier foil, are also possible.

The contact arrangements may comprise electrodes, wherein at least one of the contact arrangements comprises a layer of pressure sensitive material. Such a layer of pressure sensitive material confers a pressure depending behaviour to the pressure sensor. It should be noted that the contact arrangements are usually printed onto the respective carrier foils using a screen-printing process prior to the laminating process, in which the carrier foils and the spacer are laminated together.

To guarantee the same sensor response over the automotive temperature range (−40° C. to 105° C.), the use of a carrier foil material with a constant elasticity modulus over this temperature range is a needed. Furthermore the film should posses the following properties to fulfill e.g. the automobile and sensor manufacturing requirements: very good mechanical robustness, high chemical resistance, high resistance against humidity quick relaxation after a submission to high stress at high temperature (creep), high and constant elasticity modulus good ink adhesion or allowing an adequate coating, resist the ink stress during the ink curing (no deformation), no electrical discharging (static electricity) and low price. According to the present invention, the carrier foil therefore comprises a material chosen from the group consisting of polyetheretherketone, polyethersulfone, polyphenylsulfone, polysulfone, polycarbonate, copolycarbonate, polyphenylene ether, cyclo-olefin-polymer, polycarbonate/acrylonitrile butadiene styrene, polycarbonate/polybutylene terephthalate, polycarbonate/polyethylene terephthalate, polyphenylene ether/polyamide, or mixtures thereof. It will be noted that if necessary the carrier foil may be subject to a surface treatment in order to enhance the adhesion on the printed electrodes.

In order to provide a pressure sensor with enhanced mechanical properties as tensile strength or resistance to tear propagation, one or both of the carrier foils 12 and 14 may be provided with a multi-layered configuration comprising at least one layer of a textile material. It will be noted that the use of a textile layer may enable to enhance the above-mentioned mechanical properties without affecting the modulus of elasticity of the carrier foil. Different embodiments of such multi-layered reinforced carrier foils are shown in FIGS. 2 and 3.

FIG. 2 shows an embodiment of a multi-layered carrier foil, in which a textile layer 122 is laminated onto a polymer sheet 120. The polymer sheet may comprise a material chosen from the group consisting of imide substrates like Pi polyimide, Polyetherimide PEI, ketones substrates like PEEK, sulfonated substrates like polyphenylsulfone PPSu, polyethersulfone PES, polysulfone PSu, esters film like polyethylene terephthalate PET, polyethylene naphthalate PEN, Polycarbonate PC and Copolycarbonate CoPC, ketones like Polyetheretherketone PEEK, aramid films like polyamide PA, polyphenylsulfide PPS, cyclo-olefin-polymer COP, polyphenylene ether PPE, alloys like PC/ABS polycarbonate/Acrylonitrile Butadiene Styrene PC/PBT polycarbonate/polybutylene terephthalate PC/PET polycarbonate/polyethylene terephthalate PPE/PA polyphenylene ether/polyamide. The reinforcement layer 122 may comprise any suitable textile material such as aramid, polyamide, polyester or the like.

FIG. 3 shows an embodiment of a multi-layered carrier foil, with a further polymer layer 124, wherein the textile layer 122 is laminated between the two polymer layers 120 and 124. The polymer layer 124 may comprise a material chosen of the same group than polymer layer 120.

### LIST OF REFERENCE SIGNS

10 switching element

12 first carrier foil

14 second carrier foil

16 spacer

18 active area

20 recess or cut-out

22, 24 contact arrangements

120, 124 polymer layers

122 textile layer

1. Pressure sensor comprising at least one first carrier foil, said first carrier foil being mounted on a supporting element so as to span an active area of said pressure sensor, wherein said first carrier foil comprises a material chosen from the group consisting of copolycarbonate, polycarbonate/acrylonitrile butadiene styrene, polycarbonate/polybutylene terephthalate, polycarbonate/polyethylene terephthalate, polyphenylene ether/polyamide, and mixtures thereof.

2. Pressure sensor according to claim 1, wherein said first carrier foil comprises a polymer alloy chosen from the group consisting of polycarbonate/acrylonitrile butadiene styrene, polycarbonate/polybutylene terephthalate, polycarbonate/polyethylene terephthalate, polyphenylene ether/polyamide, and mixtures thereof.

3. Pressure sensor according to claim 1, wherein said first carrier foil comprises a polyphenylsulfone polymer or a mixture of polyphenylsulfone and one or more polymers chosen from the group consisting of polyethersulfone and polysulfone.

4. Pressure sensor according to claim 1, wherein said first carrier foil comprises a copolycarbonate or a mixture of copolycarbonate and polycarbonate.

5. Pressure sensor according to claim 1, wherein said first carrier foil comprises polyphenylsulfone and/or polyphenylene ether.

6. Pressure sensor according to claim 1, further comprising at least one second carrier foil arranged at a certain distance from said first carrier foil by means of a spacer, said spacer comprising at least one recess defining an active area of the pressure sensor, and at least two electrodes arranged in the active area of the pressure sensor between said first and second carrier foils in such a way that, in response to a pressure acting on the active area of the pressure sensor, the first and second carrier foils are pressed together against the reaction force of the elastic carrier foils and an electrical contact is established between the at least two electrodes, wherein at least one of said first and second carrier foils comprises a material chosen from the group consisting of polyetheretherketone, polyethersulfone, polyphenylsulfone, polysulfone, polycarbonate, copolycarbonate, polyphenylene ether, cyclo-olefin-polymer, polycarbonate/acrylonitrile butadiene styrene, polycarbonate/polybutylene terephthalate, polycarbonate/polyethylene terephthalate, polyphenylene ether/polyamide, and mixtures thereof.

7. Pressure sensor according to claim 6, wherein said first carrier foil and said second carrier foil comprise different materials.

8. Pressure sensor according to claim 1, wherein said first carrier foil and/or said second carrier foil comprises a multilayered configuration with at least two layers of different materials.

9. Pressure sensor according to claim 8, wherein one of said layers comprises a textile material.

10. Pressure sensor according to claim 8, wherein layers of said multi-layered carrier foil are laminated together.

11. Pressure sensor according to claim 6, wherein said first carrier foil and/or said second carrier foil comprises a multilayered configuration with at least two layers of different materials.

12. Pressure sensor according to claim 11, wherein one of said layers comprises a textile material.

13. Pressure sensor according to claim 12, wherein layers of said multi-layered carrier foil are laminated together.
